(19) United States
(12) Patent Application Publication
(10) Pub. No.: US 2012/0190359 A1
(43) Pub. Date: Jul. 26, 2012

(54) MOBILE COMMUNICATION SYSTEM, BASE STATION APPARATUS, CONTROL APPARATUS, CONTROL METHOD, AND COMPUTER READABLE MEDIUM

(75) Inventors: Hiroaki Aminaka, Tokyo (JP); Kojiro Hamabe, Tokyo (JP)

(73) Assignee: NEC CORPORATION, Minato-ku, Tokyo (JP)

(21) Appl. No.: 13/499,575

(22) PCT Filed: Aug. 6, 2010
(86) PCT No.: PCT/JP2010/004975

§ 371 Date: Mar. 30, 2012

(30) Foreign Application Priority Data
Oct. 1, 2009 (JP) 2009-229472

(51) Int. Cl. H04W 4/00

(52) U.S. Cl. 455/422.1

(57) ABSTRACT

Home base stations (1) each transmits first information including at least one of a radio parameter related to a home cell (11) formed by the home base station (1) itself and a radio parameter related to a nearby macrocell (12) measured by the home base station (1) itself. A control apparatus (5) instructs an MUE (8) connected to the macrocell (12) to measure a radio signal that arrives from the home cell (11), and receives a measurement result by the MUE (8). Further, the control apparatus (5) receives first information from each of the home base stations (1) and determines the home cell 11 which is to be measured by the MUE (8).

### TECHNICAL FIELD

The present invention relates to a mobile communication system including a home base station, and more specifically, to a configuration of a home base station or a cell formed by the home base station.

### BACKGROUND ART

A standardization organization such as 3GPP (Third Generation Partnership Project) has promoting standardization of a small base station that can be installed in a user's house, an office or the like. This small base station is arranged in a house, a small office or the like by a user, and is connected to a core network via an access line including an ADSL (Asymmetric Digital Subscriber Line), an optical fiber line or the like. Such a small base station is generally called a femto base station, a femtocell base station, or a home base station. Further, the size (coverage area) of a cell formed by the small base station is extremely small compared to those of macrocells. Thus, the cell formed by the small base station is called a femtocell or a home cell, for example. The 3GPP defines such a small base station as a Home Node B (HNB) and a Home evolved Node B (HeNB) and has promoting standardization work. The HNB is a small base station for UTRAN (Universal Mobile Telecommunications System (UMTS) Terrestrial Radio Access Network), and the HeNB is a small base station for LTE (Long term evolution)/E-UTRAN (Evolved UTRAN).

In this specification, the small base station as stated above is referred to as a “home base station”, and a cell formed by the home base station is referred to as a “home cell”. The home base stations for UTRAN and E-UTRAN studied by 3GPP are referred to as an HNB or an HeNB, or collectively referred to as an H(e)NB according to the name called in 3GPP. Further, the home cell formed by the H(e)NB is referred to as an “H(e)NB cell”.

In 3GPP Release 8, the H(e)NB is standardized as the base station managed by the user (see non-patent literature 1). However, it is difficult for the user to appropriately set configurations of the H(e)NB and H(e)NB cell (e.g. a radio frequency, a scrambling code/a physical cell ID, downlink transmission power). Accordingly, it is concerned that inappropriate configuration of the H(e)NB cell causes a problem of an interference between the M(e)NB cell and the H(e)NB cell. The M(e)NB cell is a macrocell generated by the M(e)NB (macro NodeB or macro eNodeB).

In order to suppress the interference between the H(e)NB cell and the M(e)NB cell, it has been considered that the H(e)NB shall have a function for autonomously setting the H(e)NB cell (referred to as self configuration, automatic configuration or the like). The radio parameters specify the characteristics of the radio communication of the H(e)NB cell, and more specifically, include a radio frequency band, a scrambling code, transmission power of a pilot signal (CPICH: Common Pilot Channel), and a maximum value of uplink transmission power by a mobile station, for example. Further, in order to achieve autonomous self configuration, it has also been considered that the H(e)NB shall have a function of receiving a downlink signal from a nearby M(e)NB cell (referred to as Network Listen Mode, Radio Environment Measurement or the like). The H(e)NB measures a radio signal from the M(e)NB cell and optimizes the radio parameters of the H(e)NB cell using the measurement result.

Another method that is proposed to suppress interference between the M(e)NB cell and the H(e)NB cell is to transmit configuration information of the H(e)NB cell to the H(e)NB from a control apparatus such as an RNC (Radio Network Controller) managed by a network operator (see non-patent literature 2). The H(e)NB adjusts radio parameters of the H(e)NB cell based on the received configuration information. This solving method is supposed to be used together with the self configuration stated above. Since the self configuration is supposed to be performed at the time of set-up of the H(e)NB, it may be possible that the setting of the H(e)NB cell cannot appropriately follow subsequent changes in the surrounding environment. Accordingly, when the H(e)NB cell is not appropriately set, it is required to prompt re-configuration of the H(e)NB cell by supplying the configuration information to the H(e)NB from a higher-level network.

Further, in another solving method described above, it is also examined to use the measurement result of the H(e)NB cell by a mobile station (hereinafter referred to as a macro user equipment (MUE)) connected to the M(e)NB cell in order to set radio parameters of the H(e)NB cell more appropriately. FIG. 18 shows a case of supplying configuration information from an RNC 9 to an HNB 7 of UTRAN. An MUE 8 is connected to an MNB cell 12 formed by an MNB 6. The MUE 8 measures a downlink signal from an HNB cell 11, and transmits a measurement report to the RNC 9. The RNC 9 manages the MNB 6 and the MNB cell 12. The RNC 9 generates configuration information (CFG) regarding the HNB cell 11 based on the measurement result of the HNB cell 11 by the MUE 8 and supplies the configuration information to the HNB 7. The HNB 7 adjusts radio parameters of the HNB cell 11 according to the configuration information received from the RNC 9.

### CITATION LIST

### Non Patent Literature

NPTL 1: 3GPP TR 25.820 v8.2.0 (2008-09), “3G Home Node B (HNB) study item Technical Report”

NPTL 2: 3GPP contributed article, R3-091894 “Study on Enhanced Interference Management Mechanisms for HNB”, [online], 3GPP, [searched on Sep. 19, 2009], the Internet <URL: http://www.3gpp.org/ftp/tsg_ran/WG3_Iu/TSGR3_{—}65/Docs/R3-091894.zip>

### SUMMARY OF INVENTION

### Technical Problem

As shown in FIG. 18, when the configuration of the HNB cell is performed based on the measurement result of the HNB cell by the MUE, a problem occurs that it is difficult to determine which HNB cell the MUE should measure. If the MUE measures a large number of HNB cells for all the radio resources that are allowed to be used by the HNB cells, it may lead to an increase of power consumption and degradation of communication performance of the MUE. Accordingly, it is desirable to select an H(e)NB cell which is not appropriately set in the self configuration of the HNB itself and to perform the measurement by the MUE on the selected H(e)NB cell in a limited way.

The present invention has been made in order to deal with the problems described above. One exemplary object according to the present invention is to provide a mobile communication system, a base station apparatus, a control apparatus, a control method, and a program that are able to contribute suppression of degradation of communication performance of a mobile station and an increase in power consumption in an architecture to use a measurement result of a home cell by a mobile station which attached to a macrocell in order to generate configuration information supplied to the home base station including an H(e)NB.

### Solution to Problem

In a first illustrative aspect of the present invention, a mobile communication system includes at least one first base station, a second base station, and a control unit. The first base station is configured to transmit first information including at least one of a first radio parameter related to a first cell formed by the first base station itself and a second radio parameter related to a second cell formed by the second base station and measured by the first base station itself. Further, the control unit instructs a mobile station connected to the second base station to measure a radio signal that arrives from the first base station, and receives a measurement result by the mobile station. Further, the control unit receives the first information from each of the at least one first base station, and determines a target base station which is to be measured by the mobile station from among the at least one first base station.

In a second illustrative aspect of the present invention, a base station apparatus includes a radio communication unit, a higher-level network communication unit, and a configuration control unit. The radio communication unit performs radio communication with a mobile station in a first cell. The higher-level network communication unit is capable of performing communication with a higher-level network. The configuration control unit is capable of transmitting to the higher-level network first information including at least one of a first radio parameter related to the first cell and a second radio parameter related to a second cell formed by a nearby base station.

In a third illustrative aspect of the present invention, a control apparatus for instructing a mobile station connected to a second base station to measure a radio signal that arrives from at least one first base station, and receiving a measurement result by the mobile station is provided. The control apparatus includes a control unit that receives first information from each of the at least one first base station, and determines a target base station which is to be measured by the mobile station from among the at least one first base station. Here, the first information includes at least one of a first radio parameter related to a first cell formed by a source base station from which the first information originates and a second radio parameter related to a second cell formed by the second base station and measured by the source base station.

In a fourth illustrative aspect of the present invention, a method of controlling a base station that performs radio communication with a mobile station in a first cell is provided. The method includes transmitting to a higher-level network first information including at least one of a first radio parameter related to the first cell and a second radio parameter related to a second cell formed by a nearby base station.

In a fifth illustrative aspect of the present invention, a method of controlling a control apparatus for instructing a mobile station connected to a second base station to measure a radio signal that arrives from at least one first base station and for receiving a measurement result by the mobile station is provided. The method includes receiving first information from each of the at least one first base station, and determining a target base station which is to be measured by the mobile station from among the at least one first base station. Here, the first information includes at least one of a first radio parameter related to a first cell formed by a source base station from which the first information originates and a second radio parameter related to a second cell formed by the second base station and measured by the source base station.

In a sixth illustrative aspect of the present invention, a program for causing a computer to perform processing regarding a base station is provided. The base station includes a radio communication unit for performing radio communication with a mobile station in a first cell, and a higher-level network communication unit capable of performing communication with a higher-level network. The processing performed by the computer based on the program includes transmitting, to the higher-level network via the higher-level network communication unit, first information including at least one of a first radio parameter related to the first cell and a second radio parameter related to a second cell formed by a nearby base station.

In a seventh illustrative aspect of the present invention, a program for causing a computer to perform processing for instructing a mobile station connected to a second base station to measure a radio signal that arrives from a first base station, and for receiving a measurement result by the mobile station. The processing performed by the computer based on the program includes receiving first information from each of the at least one first base station, and determining a target base station which is to be measured by the mobile station from among the at least one first base station. Here, the first information includes at least one of a first radio parameter related to a first cell formed by a source base station from which the first information originates and a second radio parameter related to a second cell formed by the second base station and measured by the source base station.

### Advantageous Effects of Invention

According to each illustrative aspect of the present invention stated above, it is possible to provide a mobile communication system, a base station apparatus, a control apparatus, a control method, and a program that are able to contribute suppression of degradation of communication performance of a mobile station and an increase in power consumption in an architecture to use a measurement result of a home cell by a mobile station which exits in a macrocell in order to generate configuration information supplied to the home base station.

### BRIEF DESCRIPTION OF DRAWINGS

FIG. 1 is a diagram showing a network configuration example of a mobile communication system according to a first illustrative embodiment of the present invention;

FIG. 2 is a diagram showing a network configuration example (a case of UTRAN) of the mobile communication system according to the first illustrative embodiment of the present invention;

FIG. 3 is a diagram showing a network configuration example (a case of LTE/E-UTRAN) of the mobile communication system according to the first illustrative embodiment of the present invention;

FIG. 4 is a diagram showing a network configuration example (a case of UTRAN) of the mobile communication system according to the first illustrative embodiment of the present invention;

FIG. 5 is a diagram showing a network configuration example (a case of UTRAN) of a mobile communication system according to a second illustrative embodiment of the present invention;

FIG. 6 is a sequence diagram showing procedures for supplying configuration information in the mobile communication system according to the second illustrative embodiment of the present invention;

FIG. 7 is a block diagram showing a configuration example of a home base station according to the second illustrative embodiment of the present invention;

FIG. 8 is a block diagram showing a configuration example of an RNC in the mobile communication system according to the second illustrative embodiment of the present invention;

FIG. 9 is a block diagram showing a configuration example of a mobile station according to the second illustrative embodiment of the present invention;

FIG. 10 is a flowchart showing a specific example of procedures for operating the home base station according to the second illustrative embodiment of the present invention;

FIG. 11 is a flowchart showing a specific example of procedures for operating the RNC according to the second illustrative embodiment of the present invention;

FIG. 12 is a flowchart showing a specific example of procedures for operating the mobile station according to the second illustrative embodiment of the present invention;

FIG. 13 is a diagram showing a network configuration example (a case of UTRAN) of a mobile communication system according to a third illustrative embodiment of the present invention;

FIG. 14 is a sequence diagram showing procedures for supplying configuration information in the mobile communication system according to the third illustrative embodiment of the present invention;

FIG. 15 is a flowchart showing a specific example of procedures for operating a home base station according to the third illustrative embodiment of the present invention;

FIG. 16 is a flowchart showing a specific example of procedures for operating an RNC according to the third illustrative embodiment of the present invention;

FIG. 17 is a sequence diagram showing procedures for supplying configuration information in a mobile communication system according to a fourth illustrative embodiment of the present invention; and

FIG. 18 is a diagram showing a configuration example of a mobile communication system according to a related art.

### DESCRIPTION OF EMBODIMENTS

In the following description, specific illustrative embodiments of the present invention will be described in detail with reference to the drawings. Throughout the drawings, the same components are denoted by the same reference symbols, and overlapping description will be omitted as appropriate for the sake of clarification of description.

### First Illustrative Embodiment

FIG. 1 is a diagram showing a network configuration example of a mobile communication system according to a first illustrative embodiment of the present invention. While only one home base station 1 is shown in FIG. 1 to simplify the explanation, plural home base stations are typically arranged in a macrocell 12. Further, each of a mobile station (not shown) connected to a home cell 11 and a mobile station 8 connected to the macrocell 12 is also generally arranged in plural number.

The home base station 1 performs bi-directional radio communication with the mobile station. Further, the home base station 1 is connected to a higher-level network (not shown) including a core network of a network operator (mobile network operator), and relays traffic between the mobile station and the higher-level network. The home cell 11 is a cell formed by the home base station 1. The home base station 1 adjusts radio parameters of the home cell 11 according to configuration information (CFG) received from a control apparatus 5 described later. The radio parameters adjusted here include, for example, a frequency band used in the home cell 11, a scrambling code, transmission power of a downlink signal, and a maximum value of uplink transmission power by the mobile station.

A macro base station 6 forms the macrocell 12 whose cell size is larger than that of the home cell 11, and performs bi-directional radio communication with the mobile station (MUE) 8. The macro base station 6 is also connected to the higher-level network (not shown), and relays traffic between the MUE 8 and the higher-level network.

The control apparatus 5 instructs the MUE 8 to measure the downlink signal that arrives from the home cell 11 by transmitting a measurement request (MEASUREMENT REQUEST) to the MUE 8. The control apparatus 5 receives from the MUE 8 a measurement report (MEASUREMENT REPORT) including the measurement result of the home cell 11. The control apparatus 5 generates configuration information (CFG) of the home cell 11 based on the measurement report from the MUE 8, and transmits the CFG to the home base station 1.

Further, the home base station 1 and the control apparatus 5 according to this illustrative embodiment perform the following operations in order to allow selection of the home cell 11 which should be measured by the MUE 8. The home base station 1 transmits “cell information” to the control apparatus 5. The control apparatus 5 determines at least one measurement target cell which should be measured by the MUE 8 among the plurality of home cells 11 based on the cell information that is received. Then, the control apparatus 5 transmits the measurement request including the information capable of specifying the home cell 11 which is determined as the measurement target cell. Accordingly, the MUE 8 only has to perform the measurement of the radio resource used by the home cell 11 which is determined as the measurement target cell. Accordingly, it is possible to suppress degradation of communication performance and an increase of power consumption of the MUE 8.

Note that the control apparatus 5 may determine the home cell 11 (or the home base station 1) which is suspected that radio setting is not appropriately performed, and selects this cell as the measurement target by the MUE 8. Accordingly, it is only required that the cell information transmitted from the home base station 1 to the control apparatus 5 includes information available for determination of an interference level between the home cell 11 and the macrocell 12.

Specifically, it is only required that the cell information transmitted from the home base station 1 to the control apparatus 5 includes at least one of “information of the home cell 11” and “measurement information of the macrocell 12”. The information of the home cell 11 includes radio parameters regarding the home cell 11 (e.g. transmission power of the downlink signal from the home base station 1, or interference level of the uplink signal in the home base station 1). The measurement information of the macrocell 12 includes radio parameters related to the macrocell 12 (e.g. reception power of the downlink signal from the macrocell 12, or information indicating whether the downlink signal can be received from the macrocell 12) measured by the home base station 1.

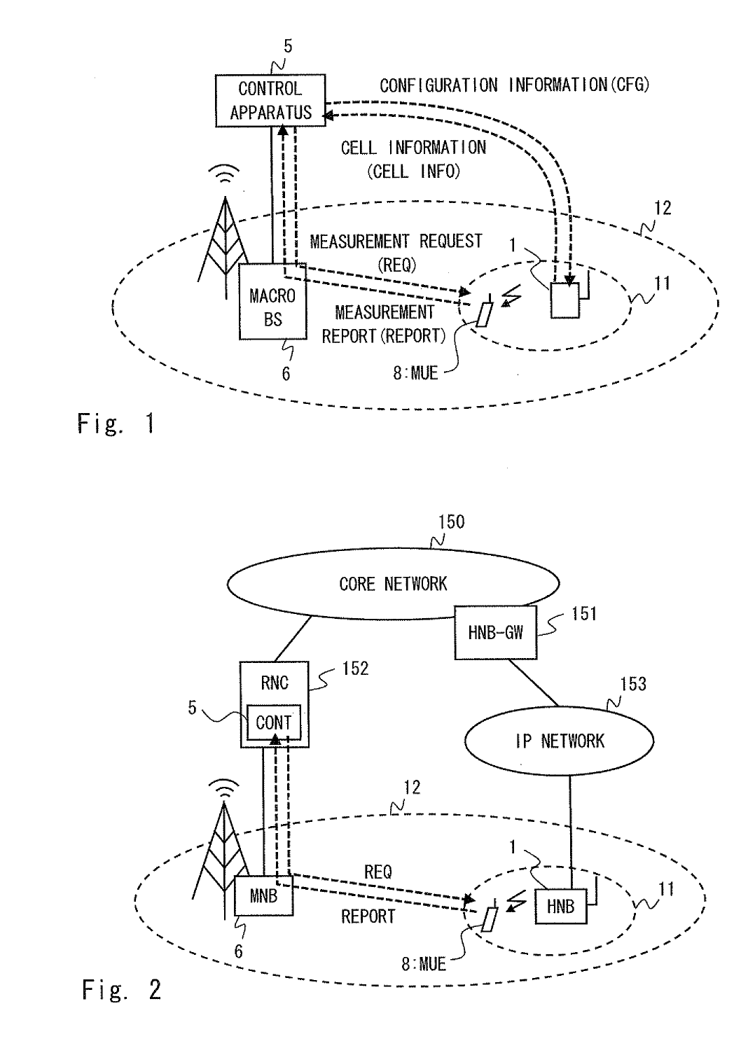

Meanwhile, the arrangement of the control apparatus 5 is determined appropriately based on the design concept of the network architecture. For example, when the mobile communication system according to the first illustrative embodiment is UMTS, as shown in FIG. 2, the function of the control apparatus 5 may be arranged in an RNC 152. FIG. 2 is a diagram showing a configuration example when the mobile communication system according to the first illustrative embodiment is applied to UMTS. In the example shown in FIG. 2, the home base station (HNB) 1 is connected to a core network 150 via an IP (Internet Protocol) network 153 and an HNB-GW 151. Further, the macro base station (MNB) 6 is connected to the core network 150 via the RNC 152. The HNB-GW 151 is arranged between the core network 150 and the home base station (HNB) 1, and relays control data including CFG 2 and user data between them. The RNC 152 is arranged between the core network 150 and the NMB 6, and relays user data and control data between them. Further, the RNC 152 performs management of the radio resource of the macrocell 12, and control of inter-cell movement of the mobile station 8-2 attached to the macrocell 12.

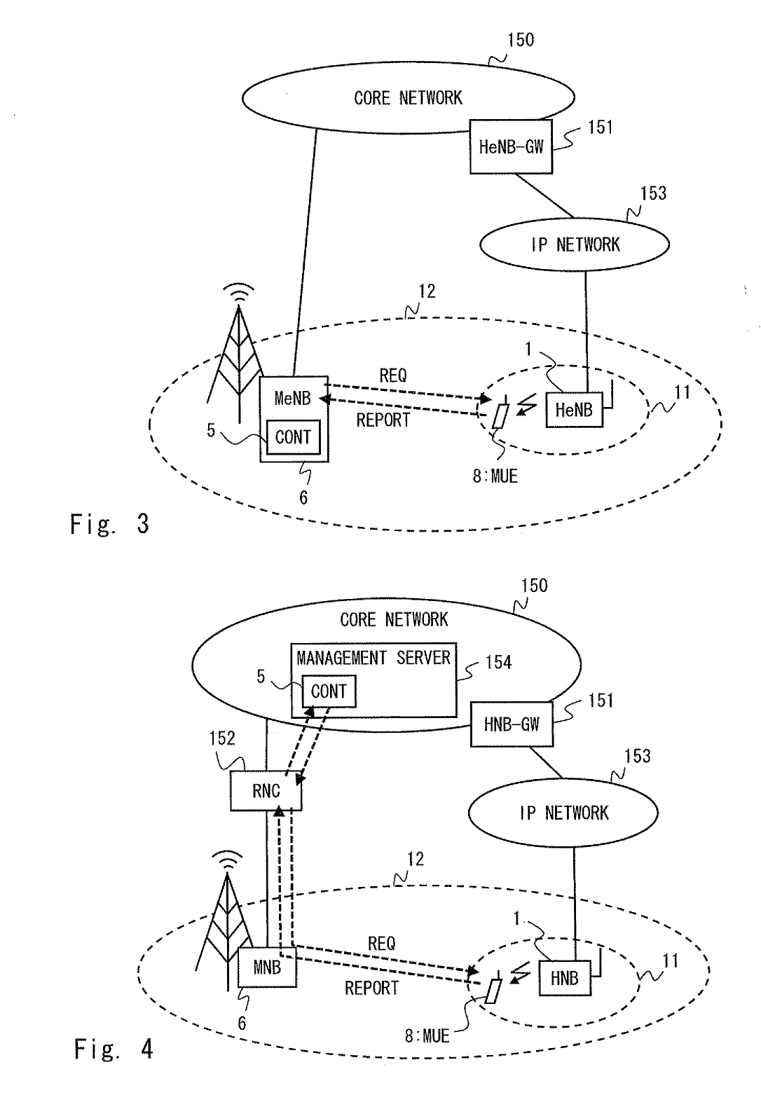

Further, when the mobile communication system according to the first illustrative embodiment is an EPS (Evolved Packet System), as shown in FIG. 3, the function of the control apparatus 5 may be integrally arranged with the macro base station (macro eNB (MeNB)) 6. FIG. 3 is a diagram showing a configuration example of the mobile communication system according to the first illustrative embodiment when the system is applied to the EPS.

Further, as shown in FIG. 4, the function of the control apparatus 5 may be arranged in a management server 154 in the core network 150. While shown in FIG. 4 is a case of UMTS, the same is applied to other mobile communication systems including the EPS.

Further, the functions of the control apparatus 5 may be arranged separately in the mobile communication system. For example, in the example of FIG. 4, the functions of receiving the cell information from the HNB 1 and generating the configuration information may be arranged in the management server 154, and the functions of transmitting the measurement request to the MUE 8 and receiving the measurement report may be arranged in the RNC 152.

In the following second to fourth illustrative embodiments, specific examples of methods of selecting the home cell 11 (home base station 1) which is to be measured by the MUE 8 will be described in detail. Although the second to fourth illustrative embodiments describe the case of UMTS/UTRAN in detail, these illustrative embodiments may naturally be applied to other systems including EPS (Evolved Packet System)/E-UTRAN.

### Second Illustrative Embodiment

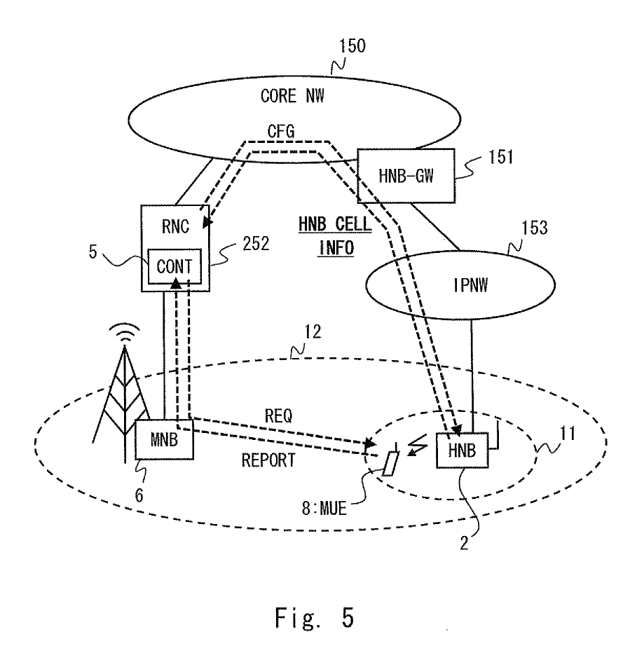

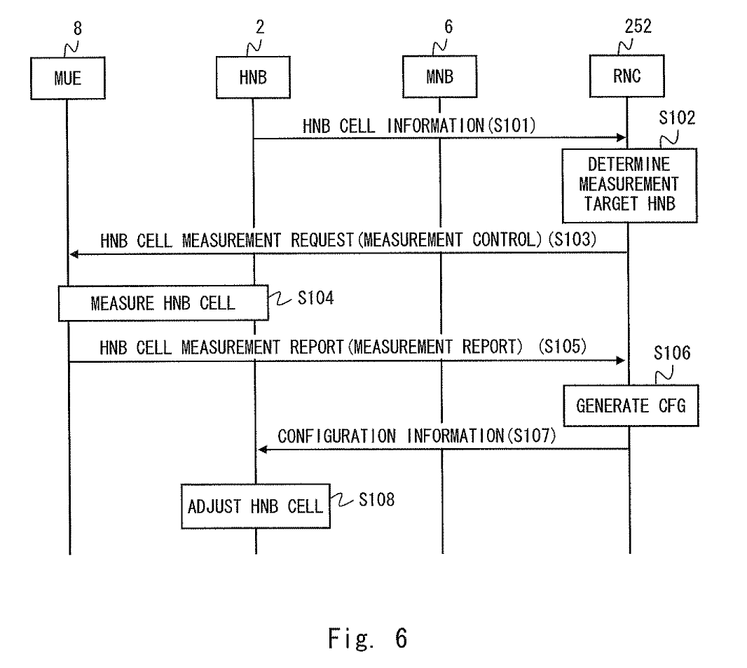

FIG. 5 shows a configuration example of a mobile communication system according to a second illustrative embodiment. In this illustrative embodiment, a home base station (HNB) 2 transmits “HNB cell information” including the information of the home cell (HNB cell) 11 to an RNC 252. Further, the RNC 252 executes the operation of the control apparatus 5 described above. In the following, an operation of the second illustrative embodiment will be described with reference to FIG. 6.

FIG. 6 is a sequence diagram showing procedures for supplying the configuration information to the HNB 2 according to this illustrative embodiment. In step S101, the HNB 2 transmits the “HNB cell information” including the information of the home cell 11 to the RNC 252. Specific examples of the radio parameters included in the HNB cell information include transmission power of the downlink signal of the HNB 2, the interference level of the uplink signal received by the HNB 2 and the like. Among them, the transmission power of the downlink signal of the HNB 2 may be used to evaluate the interference from the HNB cell 11 to the MUE 8. This is because large transmission power of the HNB 2 may be an interference factor to the downlink signal that arrives from the MNB 6 to the mobile station (e.g. MUE 8) which belongs to the macrocell (MNB cell) 12. On the other hand, the interference level of the uplink signal received by the HNB 2 can be used to evaluate the interference from the MUE 8 to the HNB cell 11.

In step S102, the RNC 252 determines the HNB cell 11 (or HNB 2) which should be measured by the MUE 8 based on the HNB cell information received from the HNB 2. For example, when the HNB cell information includes “transmission power of the downlink signal of the HNB 2”, the HNB cell 11 where “transmission power of the downlink signal of the HNB 2” exceeds a predetermined reference value may be determined as the measurement target. This is because, in this case, there is a possibility that the interference from the HNB cell 11 to a nearby cell (including the MNB cell 12) exceeds an allowable range. Further, when the HNB cell information includes the “interference level of the uplink signal received by the HNB 2”, the HNB cell 11 where “interference level of the uplink signal received by the HNB 2” exceeds a predetermined reference value may be determined as the measurement target. This is because, in this case, there is a possibility that the interference from the nearby cell (including the MNB cell 12) to the HNB cell 11 exceeds an allowable range.

In step S103, the RNC 252 transmits to the MUE 8 the HNB cell measurement request including the specification of the HNB cell (or HNB 2) selected as the measurement target. This request may be transmitted using “Measurement Control” which is one of radio resource control (RRC) messages, for example. The specification of the measurement target HNB may be performed using at least one of a radio frequency, a scrambling code, and a cell ID of the HNB cell. The HNB cell measurement request may include information indicating a period in which the transmission from the MNB 6 is stopped for the measurement of the HNB cell. Accordingly; the MUE 8 is able to perform accurate measurement with eliminating influence of the downlink signal from the MNB 6.

The RNC 252 may select the MUE 8 positioned near the measurement target HNB 2 which is the measurement target to transmit the measurement request. A GPS (global positioning system) may be used to determine the positions of the HNB 2 and the MUE 8. More specifically, a GPS (global positioning system) receiver may be provided in each of the HNB 2 and the MUE 8, and the RNC 252 or a server (not shown) arranged in the core network 150 may collect positional information of the HNB 2 and the MUE 8. Then, the MUE 8 located near the measurement target HNB 2 which is the may be selected by comparing the positional information of the HNB 2 with the positional information of the MUE 8.

Referring back to FIG. 6, the description will be continued. In step S104, the MUE 8 performs the measurement of the downlink signal from the HNB 2 specified by the HNB cell measurement request. In step S105, the MUE 8 reports the measurement result of the HNB cell 11 to the RNC 252. This measurement report may be performed using “Measurement Report” which is one of the radio resource control (RRC) messages, for example.

In step S106, the RNC 252 generates the configuration information (CFG) to be transmitted to the measurement target HNB 2 based on the HNB cell measurement report. Specifically, when the interference from the HNB cell 11 to the MNB cell 12 is too large, the CFG including the instruction to decrease the downlink transmission power of the HNB 2 may be generated. In contrast, when the interference from the MNB cell 12 to the HNB cell 11 is too large, the CFG including the instruction that allows the increase of the downlink transmission power of the HNB 2 may be generated.

In step S107, the RNC 252 transmits the configuration information (CFG) to the measurement target HNB 2 which is determined as the measurement target. As one example, the configuration information (CFG) may be transmitted to the HNB 2 via the core network 150, the HNB-GW 151, the IP network 153, and an access line between the IP network 153 and the HNB 2. Further, the configuration information (CFG) may be broadcasted to the MNB cell 12 from via the downlink radio channel. Further, these two transmission paths may be used together in order to transmit the configuration information (CFG).

Lastly, in step S108, the HNB 2 adjusts its own HNB cell 11 according to the configuration information (CFG) that arrives from the RNC 252.

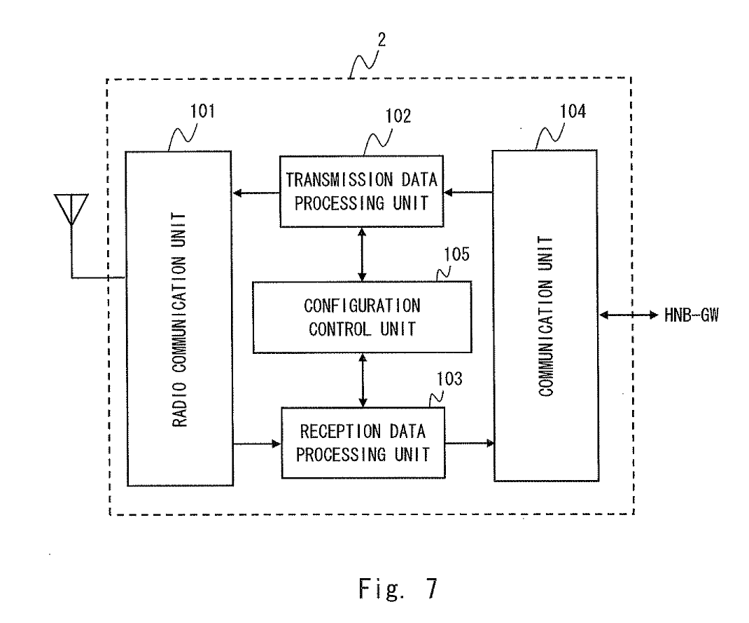

Subsequently, in the following description, with reference to FIGS. 7 to 9, configuration examples of the HNB 2, the RNC 252, and the MUE 8 will be described. FIG. 7 is a block diagram showing an example of the configuration of the HNB 2. In FIG. 7, a radio communication unit 101 performs each processing including quadrature modulation, frequency conversion, and signal amplification on a transmission symbol sequence supplied from a transmission data processing unit 102 to generate a downlink signal, and transmits the downlink signal to the mobile station. Further, the radio communication unit 101 receives an uplink signal transmitted from the mobile station.

The transmission data processing unit 102 acquires from a communication unit 104 the transmission data transmitted to the mobile station, performs error correction coding, rate matching, interleaving or the like to generate a transport channel. Further, the transmission data processing unit 102 adds control information including a TPC (Transmit Power Control) bit or the like to data series of the transport channel to generate a radio frame. Further, the transmission data processing unit 102 performs spreading processing and symbol mapping to generate a transmission symbol sequence.

Further, upon receiving the configuration information (CFG) from the core network 150, the transmission data processing unit 102 transfers the CFG to a configuration control unit 105.

A reception data processing unit 103 performs each processing including de-spreading, RAKE synthesis, de-interleaving, channel decoding, and error correction of the uplink signal received by the radio communication unit 101 to restore the reception data. The resulting reception data is transferred to the HNB-GW 151 and the core network 150 via the communication unit 104.

Further, the radio communication unit 101 may include a function (Network Listen Mode) of receiving the downlink signal from a nearby base station such as the MNB 7. In this case, the radio communication unit 101 receives the downlink signal transmitted from the MNB 7 and performs measurement of the reception quality. Further, when the operation mode of the radio communication unit 101 is a mode (Network Listen Mode) to receive the downlink signal from the nearby base station, the reception data processing unit 103 may acquire the cell configuration information (CFG) from the reception data.

The configuration control unit 105 generates the HNB cell information, and transmits the HNB cell information to the core network 150 via the reception data processing unit 103 and the communication unit 104. Further, the configuration control unit 105 adjusts the radio parameters of the HNB cell 11 according to the configuration information (CFG) received by the transmission data processing unit 102 or the reception data processing unit 103.

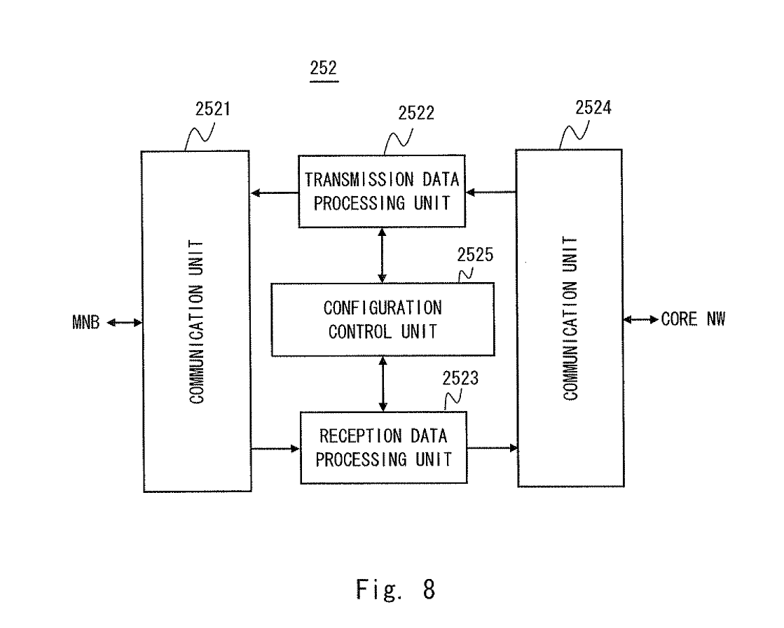

FIG. 8 is a block diagram showing a configuration example of the RNC 252. A communication unit 2521 transmits/receives user data and control data to/from the MNB 6. A transmission data processing unit 2522 acquires transmission data which is to be transmitted to the MUE 8 and the MNB 6 from a communication unit 2524. Further, upon receiving the configuration information (CFG) from a configuration control unit 2525, the transmission data processing unit 2522 notifies the MNB cell 12 of the configuration information (CFG) via the communication unit 2521 and the MNB 6.

A reception data processing unit 2523 transfers the data received from the communication unit 2521 to the core network 150 via the communication unit 2524. Further, upon receiving the configuration information (CFG) from the configuration control unit 2525, the reception data processing unit 2523 transmits the CFG to the destination HNB 2 via the communication unit 2524 and the core network 150.

The configuration control unit 2525 receives the HNB cell information from the HNB 2, and determines whether to select the source HNB 2 from which the information originates as the measurement target by the MUE 8 based on the information. The configuration control unit 2525 transmits the HNB cell measurement request including the specification of the HNB cell 11 (or HNB 2) selected as the measurement target to the MUE 8 via the transmission data processing unit 2522 and the communication unit 2521. The configuration control unit 2525 generates the configuration information (CFG) to be transmitted to the HNB 2 which is determined as the measurement target based on the HNB cell measurement report received from the MUE 8. Further, the configuration control unit 2525 transmits the configuration information (CFG) that is generated to the HNB 2 which is determined as the measurement target by the MUE 8.

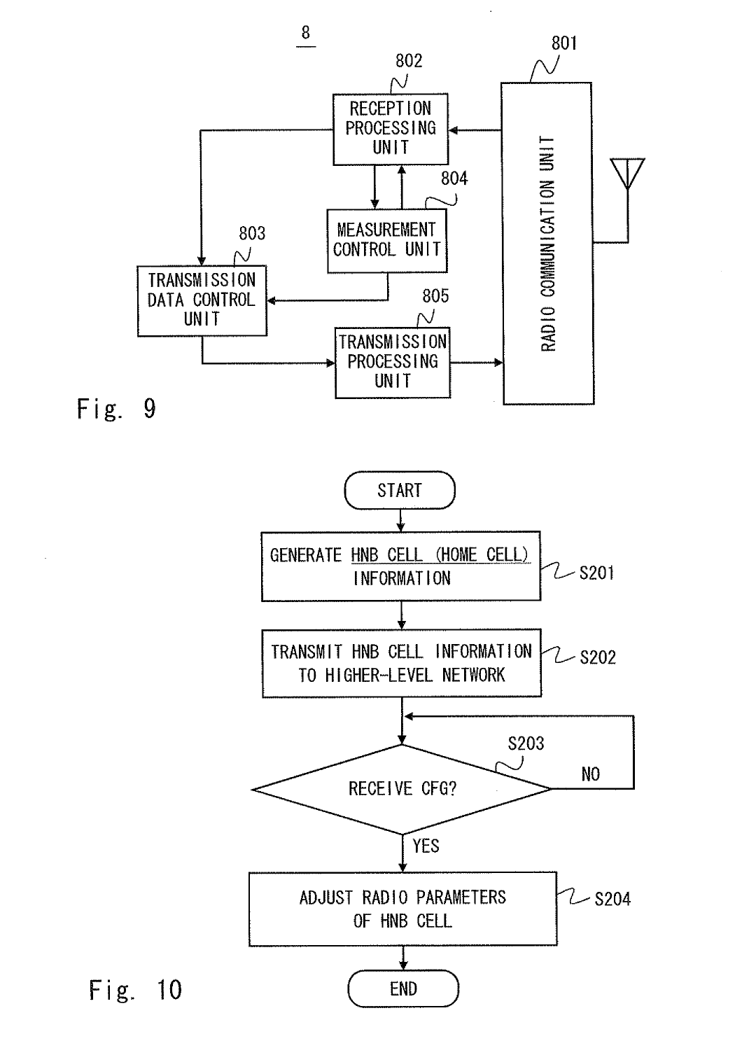

FIG. 9 is a block diagram showing a configuration example of the MUE 8 according to the second illustrative embodiment. FIG. 9 shows parts related to the measurement of the nearby HNB cell, and other components are omitted. In FIG. 9, a radio communication unit 801 performs radio communication with the MNB 6.

A reception processing unit 802 receives data from the MNB 6, and transfers the data to a measurement control unit 804 when the reception data is the HNB cell measurement request. Further, the reception processing unit 802 performs the measurement of the MNB cell 11 specified according to the measurement instruction from the measurement control unit 804, and reports the measurement result to the measurement control unit 804.

Upon receiving an HNB cell measurement request, the measurement control unit 804 instructs the reception processing unit 802 to measure the specified MNB cell 11. Further, the measurement control unit 804 receives the measurement result of the home cell 11 from the reception processing unit 802, and instructs a transmission data control unit 803 to transmit the measurement result to the RNC 552.

The transmission data control unit 803 executes start or stop of the uplink data transmission according to the instruction from the measurement control unit 804. A transmission processing unit 805 generates an uplink signal, and transmits the uplink signal to the MNB 6 via the radio communication unit 801.

In the following description, each operation of the HNB 2, the RNC 252, and the MUE 8 will be described with reference to a flowchart. FIG. 10 is a flowchart showing a specific example of the operation of the HNB 2. In step S201, the HNB 2 generates the HNB cell information regarding the HNB cell 11 that the HNB 2 generates. In step S202, the HNB 2 transmits the HNB cell information to the higher-level network (the IP network 153, the HNB-GW 152, and the core network 150). In step S203, the HNB 2 determines whether the configuration information (CFG) is received from the RNC 252. Upon receiving the CFG (YES in step S203), the HNB 2 adjusts the radio parameters of its own HNB cell 11 according to the CFG that is received (step S204).

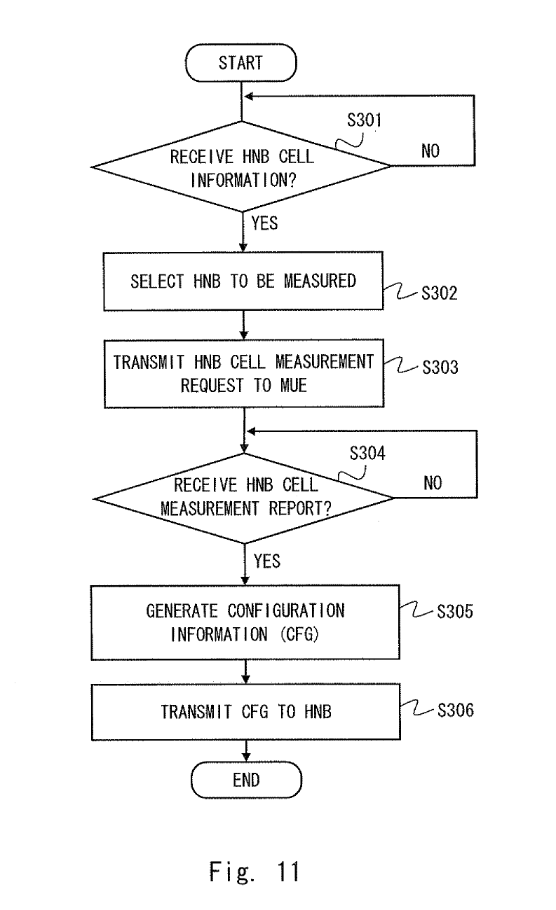

FIG. 11 is a flowchart showing a specific example of the operation of the RNC 252. In step S301, the RNC 252 determines whether the HNB cell information from the HNB 2 is received. Upon receiving the HNB cell information (YES in step S301), the RNC 252 performs selection of the measurement target HNB based on the HNB cell information that is received (step S302). In step S303, the HNB cell measurement request including the specification of the HNB cell 11 (or HNB 2) selected as the measurement target is transmitted to the MUE 8. In step S304, the RNC 252 determines whether the HNB cell measurement report from the MUE 8 is received. Upon receiving the HNB cell measurement report (YES in step S304), the RNC 252 generates the configuration information (CFG) regarding the measurement target HNB cell 11 based on the measurement report received from the MUE 8 (step S305). Lastly, in step S306, the RNC 252 transmits the CFG to the measurement target HNB 2.

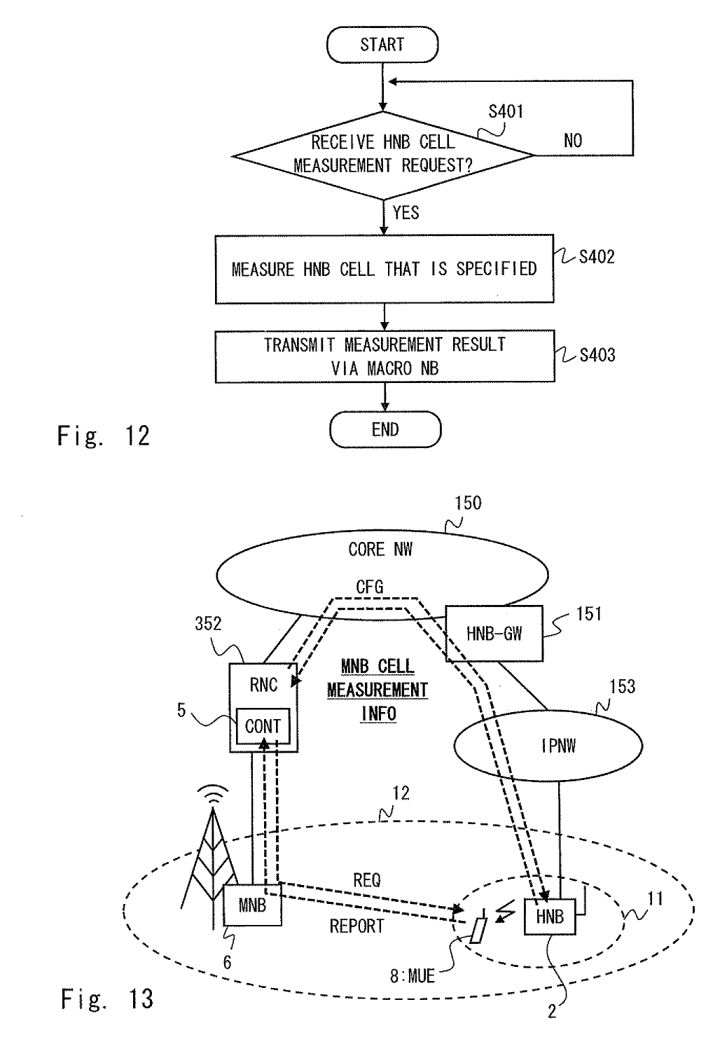

FIG. 12 is a flowchart showing a specific example of an operation of the MUE 8. In step S401, MUE 8 determines whether the HNB cell measurement request from the RNC 252 is received via the MNB 6. Upon receiving the HNB cell measurement request (YES in step S401), the MUE 8 measures the downlink signal that arrives from the HNB cell 11 specified by the measurement request. In step S403, the HNB cell measurement result is transmitted to the RNC 252 via the MNB 6.

As described above, in the second illustrative embodiment, the RNC 252 is able to determine the HNB cell 11 (or HNB 2) which is suspected that the setting of the radio parameters is not appropriate by referring to the “HNB cell information” transmitted from the HNB 2 to the RNC 252 (control apparatus 5). Accordingly, it is possible to narrow down the cell(s) which should be measured by the MUE 8.

### Third Illustrative Embodiment

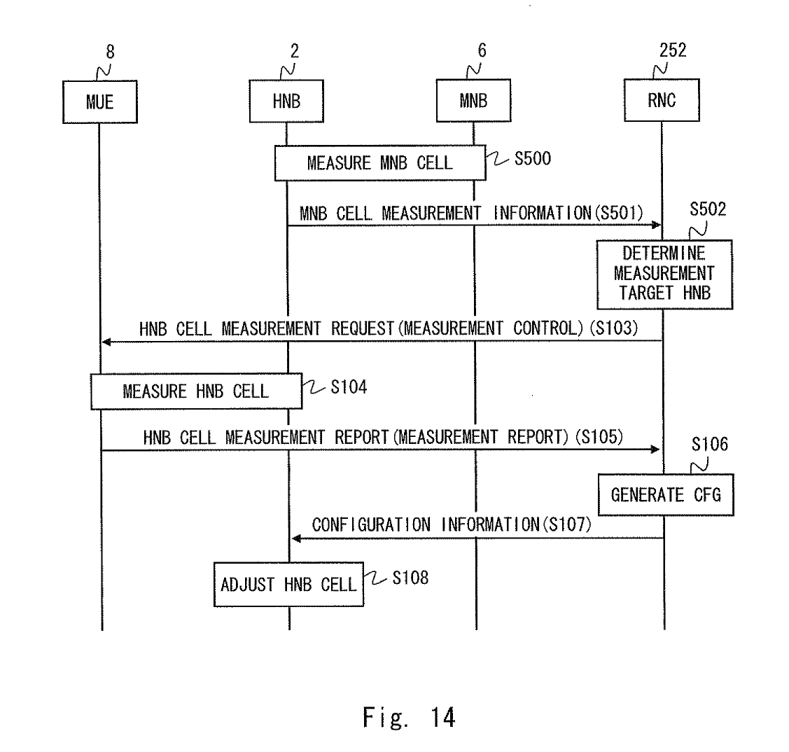

FIG. 13 shows a configuration example of a mobile communication system according to a third illustrative embodiment. In the third illustrative embodiment, a home base station (HNB) 3 transmits the “MNB cell measurement information” including the measurement information of the macrocell (MNB cell) 12 that the HNB 3 has measured to an RNC 352. Further, the RNC 352 executes the operation of the control apparatus 5 described above. In the following description, an operation according to the third illustrative embodiment will be described with reference to FIG. 14.

FIG. 14 is a sequence diagram showing procedures for supplying configuration information to the HNB 3 according to the third illustrative embodiment. In step S500, the HNB 3 performs the measurement of the nearby MNB cell 12. In step S501, the HNB 3 transmits the “MNB cell measurement information” including the measurement result of the MNB cell 12 to the RNC 352. Specific examples of the radio parameters included in the MNB cell measurement information include reception power of a downlink signal from the MNB cell 12, information indicating whether the downlink signal can be received from the MNB cell 12 and the like. They can be used to evaluate the interference from the MUE 8 to the HNB cell 11, and the interference from the HNB cell 11 to the MUE 8.

In step S502, the RNC 352 determines the HNB cell 11 (or HNB 3) which should be measured by the MUE 8 based on the MNB cell measurement information received from the HNB 3. For example, when the MNB cell measurement information includes “the reception power of the downlink signal from the MNB cell 12”, the HNB cell 11 where “the reception power of the downlink signal from the MNB cell 12” exceeds a predetermined reference value may be determined as the measurement target. This is because, in this case, there is a possibility that the interference from the MNB cell 12 to the HNB cell 11 exceeds an allowable range.

Further, when the MNB cell measurement information includes “whether the downlink signal can be received from the MNB cell 12”, the HNB cell 11 where the downlink signal from the MNB cell 12 cannot be received may be determined as the measurement target. The case in which the downlink signal cannot be received includes a case in which the reception level of a pilot signal (CPICH) is equal to or smaller than a threshold, or a case in which an SIB (System Information Block) cannot be received. This is because, in such cases, there is a possibility that the interference from the HNB cell 11 to the nearby cell (including the MNB cell 12) exceeds an allowable range.

Steps S103 to S108 in FIG. 14 are similar to steps S103 to S108 shown in FIG. 6.

In the following description, the operations of the HNB 3 and the RNC 352 will be described according to flowcharts. Since the measurement operation of the MNB cell 11 by the MUE 8 according to the third illustrative embodiment is similar to that of the second illustrative embodiment described above, the overlapping description will be omitted.

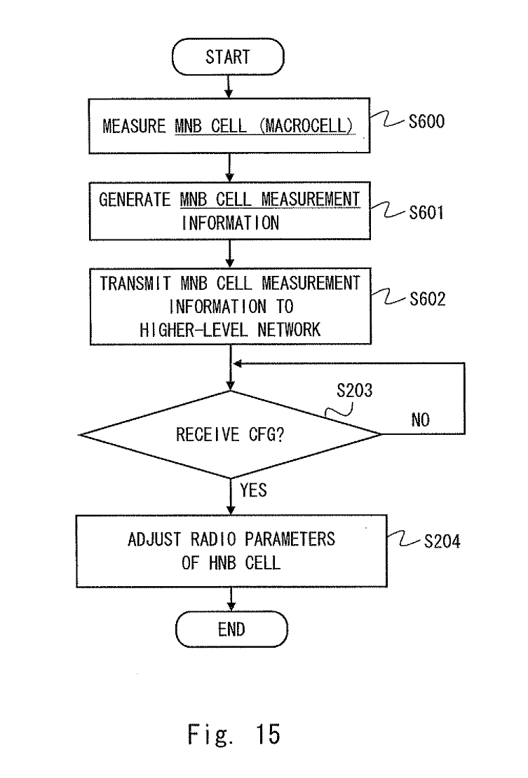

FIG. 15 is a flowchart showing a specific example of the operation of the HNB 3. In step S600, the HNB 3 performs the measurement of the MNB cell 12. In step S601, the HNB 3 generates the MNB cell measurement information including the measurement result in step S600. In step S602, the HNB 3 transmits the MNB cell measurement information that is generated to the higher-level network (the IP network 153, the HNB-GW 152, and the core network 150). The operations performed in steps S203 and S204 in FIG. 15 are similar to steps S203 and S204 shown in FIG. 10.

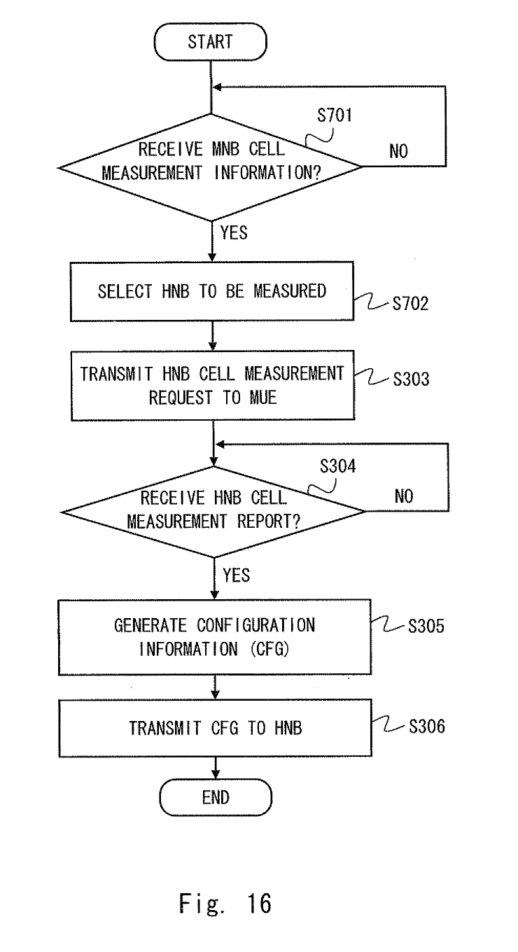

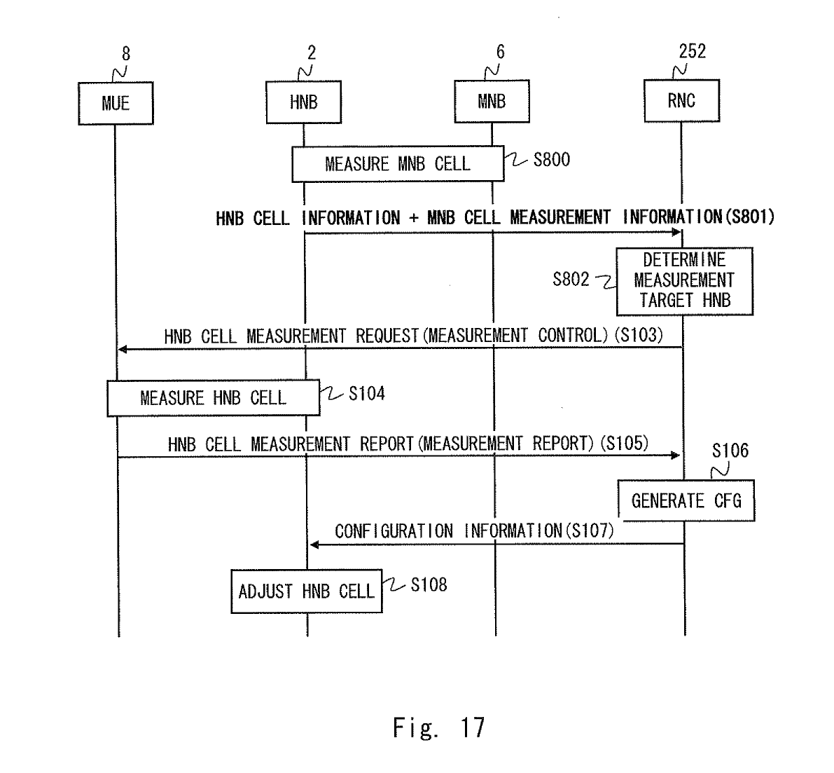

Next, FIG. 16 is a flowchart showing a specific example of an operation of the RNC 352. In step S701, the RNC 352 determines whether it received the MNB cell measurement information from the HNB 3. In step S702, the RNC 352 selects the measurement target HNB based on the MNB cell measurement information that is received. Step 5303 to 5306 shown in FIG. 16 are similar to steps S303 to S306 shown in FIG. 11.

As described above, according to the third illustrative embodiment, the RNC 352 is able to determine the HNB cell 11 (or HNB 3) which is suspected that the setting of the radio parameters is not appropriate by referring to the “MNB cell measurement information” transmitted from the HNB 3 to the RNC 352 (control apparatus 5). Accordingly, it is possible to narrow down the cell which should be measured by the MUE 8.

### Fourth Illustrative Embodiment

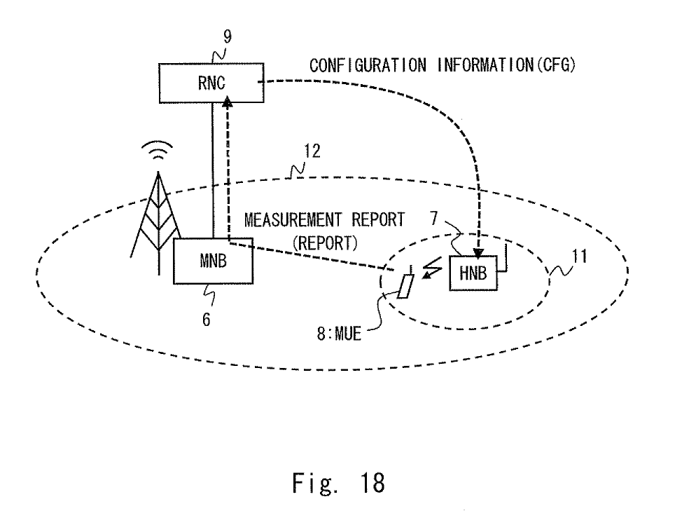

In a fourth illustrative embodiment, combinations of the second and third illustrative embodiments will be described. Specifically, according to this illustrative embodiment, a home base station (HNB) 4 transmits both of the “HNB cell information” and the “MNB cell measurement information” to an RNC 452. The RNC 452 determines the measurement target HNB in consideration of both of the “HNB cell information” and the “MNB cell measurement information”. In the following, an operation according to this illustrative embodiment will be described with reference to FIG. 17.

FIG. 17 is a sequence diagram showing procedures for supplying configuration information to the HNB 4 according to this illustrative embodiment. In step S800, the HNB 4 performs the measurement of the MNB cell 12 formed by the MNB 6. In step S801, the HNB 4 transmits the “HNB cell information” regarding the HNB cell 11 formed by itself and the “MNB cell measurement information” including the measurement result of the MNB cell 12 to the RNC 452.

In step S802, the RNC 452 determines the HNB cell 11 (or HNB 4) which should be measured by the MUE 8 based on the MNB cell measurement information and the HNB cell information received from the HNB 4. Steps S103-S108 shown in FIG. 17 are similar to steps S103-S108 shown in FIG. 6.

Note that, in step S802, the RNC 452 may determine the final measurement target HNB cell using the determination result of the measurement target cell based on the HNB cell information and the determination result of the measurement target HNB cell based on the MNB cell measurement information. The procedures for determining the measurement target cell based on the HNB cell information is as described with reference to step S102 in FIG. 6 according to the second illustrative embodiment. Further, the procedures for determining the measurement target HNB cell based on the MNB cell measurement information is as described with reference to step S502 of FIG. 14 according to the third illustrative embodiment.

In one example, the RNC 452 may select, as the final measurement target, the HNB cell 11 included in both of the determination result of the measurement target cell based on the HNB cell information and the determination result of the measurement target

HNB cell based on the MNB cell measurement information. This allows to narrow down the measurement target cell, whereby the measurement load of the MUE 8 may further be mitigated.

Further, in another example, the RNC 452 may select, as the measurement target, all the HNB cells 11 included in at least one of the determination result of the measurement target cell based on the HNB cell information and the determination result of the measurement target HNB cell based on the MNB cell measurement information. Accordingly, it is possible to comprehensively examine the HNB cell 11 which is suspected that the adjustment of the radio parameters may not appropriate, which can contribute to suppression of inter-cell interference and improvement of communication quality of the whole system.

### Other Illustrative Embodiments

In the second to fourth illustrative embodiments, the case of UMTS has been described in detail. However, the method of selecting the measurement target home cell and the method of supplying the configuration information to the home base station described in these illustrative embodiments may be naturally applied to other systems including an EPS.

Processing performed in each apparatus (the control apparatus 5, the management server 154, the home base stations 1-4, the mobile station 8, and the RNCs 152, 252, 352, and 452) described in the above first to fourth illustrative embodiments may be achieved using a computer system including an ASIC (Application Specific Integrated Circuit), a DSP (Digital Signal Processor), an MPU (Micro Processing Unit) or a CPU (Central Processing Unit), or combinations thereof. More specifically, it is possible to cause a computer system to execute a program including instructions regarding processing procedures of each apparatus described using the sequence diagrams or the flowcharts.

These programs can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Furthermore, the present invention is not limited to the illustrative embodiments described above, but various changes may be made to the present invention within the spirit of the present invention already described.

This application claims the benefit of priority, and incorporates herein by reference in its entirety, the following Japanese Patent Application No. 2009-229472 filed on October 1, 2009.

### REFERENCE SIGNS LIST

1 HOME BASE STATION
2-4 HOME BASE STATION (HNB)
5 CONTROL APPARATUS
6 MACRO BASE STATION (M(e)NB)
8 MACRO MOBILE STATION (MUE)
11 HOME CELL
12 MACROCELL
150 CORE NETWORK
151 H(e)NB GATEWAY (H(e)NB-GW)
152, 252, 353, 452 RNC
153 IP NETWORK
154 MANAGEMENT SERVER

1. A mobile communication system comprising:
at least one first base station;
a second base station; and
control unit being configured to instruct a mobile station connected to the second base station to measure a radio signal that arrives from the first base station, and to receive a measurement result by the mobile station, wherein
the first base station transmits first information including at least one of a first radio parameter related to a first cell formed by the first base station itself and a second radio parameter related to a second cell formed by the second base station and measured by the first base station itself, and
the control unit is further configured to receive the first information from each of the at least one first base station, and to determine a target base station which is to be measured by the mobile station from among the at least one first base station.

2. The mobile communication system according to claim 1, wherein the control unit is further configured to instruct the target base station to adjust its own first cell based on the measurement result by the mobile station.

3. The mobile communication system according to claim 1, wherein the control unit transmits a measurement request including information capable of specifying a radio resource used by the target base station to the mobile station.

4. The mobile communication system according to claim 3, wherein the mobile station measures a downlink signal that arrives from the target base station specified based on the measurement request.

5. The mobile communication system according to claim 1, wherein the first information further includes at least one of information indicating a radio frequency used in the first cell and identification information of the first cell.

6. The mobile communication system according to claim 1, wherein the first radio parameter includes transmission power of a downlink signal by the first base station.

7. The mobile communication system according to claim 1, wherein the first radio parameter includes an interference level of an uplink signal that the first base station receives from the mobile station.

8. The mobile communication system according to claim 1, wherein the second radio parameter includes reception power of a downlink signal transmitted from the second base station.

9. The mobile communication system according to claim 1, wherein the second radio parameter includes information indicating whether the downlink signal transmitted from the second base station can be received.

10. The mobile communication system according to claim 1, wherein the first information arrives at the control unit via a management apparatus that manages the first base station.

11. The mobile communication system according to claim 3, wherein the control unit compares positional information of at least one mobile station connected to the second base station with positional information of the first base station to determine a mobile station to which the measurement request is to be transmitted.

12. The mobile communication system according to claim 1, wherein:
the at least one first base station and the second base station are connected to a higher-level network, and
the control unit is arranged in the higher-level network.

13. The mobile communication system according to claim 1, wherein the first base station is a base station to which only a predetermined mobile station is allowed to connect.

14. A base station apparatus comprising:
radio communication unit being configured to perform radio communication with a mobile station in a first cell;
higher-level network communication unit being configured to perform communication with a higher-level network; and
configuration control unit being configured to adjust radio characteristics of the first cell,
wherein the configuration control unit is able to transmit to the higher-level network first information including at least one of a first radio parameter related to the first cell and a second radio parameter related to a second cell formed by a nearby base station.

15. The base station apparatus according to claim 14, wherein the configuration control unit receives configuration information supplied from the higher-level network as a response to the first information, and adjusts the radio characteristics of the first cell according to the configuration information.

16. The base station apparatus according to claim 14, wherein
the radio communication unit is able to receive a radio signal from the nearby base station, and
the second radio parameter is measured by the radio communication unit.

17. The base station apparatus according to claim 14, wherein the configuration information is generated based on a measurement result of a downlink signal from the first cell by the mobile station connected to the nearby base station.

18. The base station apparatus according to claim 14, wherein the first information further includes at least one of information indicating a radio frequency used in the first cell and identification information of the first cell.

19. The base station apparatus according to claim 14, wherein the first radio parameter includes transmission power of a downlink signal by the base station apparatus.

20. The base station apparatus according to claim 14, wherein the first radio parameter includes an interference level of an uplink signal that the base station apparatus receives from the mobile station.

21. The base station apparatus according to claim 14, wherein the second radio parameter includes reception power of a downlink signal transmitted from the nearby base station.

22. The base station apparatus according to claim 14, wherein the second radio parameter includes information indicating whether the downlink signal transmitted from the nearby base station can be received.

23. A control apparatus for instructing a mobile station connected to a second base station to measure a radio signal that arrives from at least one first base station and receiving a measurement result by the mobile station, the control apparatus comprising:
Control unit being configured to receive first information from each of the at least one first base station, and to determine a target base station which is to be measured by the mobile station from among the at least one first base station,
wherein the first information includes at least one of a first radio parameter related to a first cell formed by a source base station from which the first information originates and a second radio parameter related to a second cell formed by the second base station and measured by the source base station.

24. The control apparatus according to claim 23, wherein the control unit is further configured to instruct the target base station to adjust its own first cell based on the measurement result by the mobile station.

25. The control apparatus according to claim 23, wherein the control unit transmits a measurement request including information capable of specifying a radio resource used by the target base station to the mobile station.

26. The control apparatus according to claim 23, wherein the first information further includes at least one of information indicating a radio frequency used by the first cell and identification information of the first cell.

27. The control apparatus according to claim 23, wherein the first radio parameter includes at least one of transmission power of a downlink signal by the first base station, and an interference level of an uplink signal that the first base station receives from the mobile station.

28. The control apparatus according to claim 23, wherein the second radio parameter includes at least one of reception power of a downlink signal transmitted from the second base station, and information indicating whether a downlink signal transmitted from the second base station can be received.

29. The control apparatus according to claim 23, wherein the first information arrives at the control apparatus via a management apparatus that manages the first base station.

30. The control apparatus according to claim 25, wherein the control unit compares positional information of at least one mobile station connected to the second base station with positional information of the first base station to determine a mobile station to which the measurement request is transmitted.

31. The control apparatus according to claim 23, wherein
the at least one first base station and the second base station are connected to a higher-level network, and
the control apparatus is arranged in the higher-level network.

32. A method of controlling a base station that performs radio communication with a mobile station in a first cell, the method comprising
transmitting to a higher-level network first information including at least one of a first radio parameter related to the first cell and a second radio parameter related to a second cell formed by a nearby base station.

33. The method according to claim 32, further comprising:
receiving configuration information supplied from the higher-level network as a response to the first information; and
adjusting radio characteristics of the first cell according to the configuration information.

34. A method of controlling a control apparatus for instructing a mobile station connected to a second base station to measure a radio signal that arrives from at least one first base station and for receiving a measurement result by the mobile station, the method comprising:
receiving first information from each of the at least one first base station; and
determining a target base station which is to be measured by the mobile station from among the at least one first base station,
wherein the first information includes at least one of a first radio parameter related to a first cell formed by a source base station from which the first information originates and a radio parameter related to a second cell formed by the second base station and measured by the source base station.

35. A non-transitory computer readable medium storing a program for causing a computer to perform processing regarding a base station, wherein
the base station comprises:
radio communication unit being configured to perform radio communication with a mobile station in a first cell; and
higher-level network communication unit being configured to perform communication with a higher-level network, and
the processing comprises transmitting, to the higher-level network via the higher-level network communication unit, first information including at least one of a first radio parameter related to the first cell and a second radio parameter related to a second cell formed by a nearby base station.

36. The computer readable medium according to claim 35, wherein the processing further comprises:
receiving configuration information supplied from the higher-level network as a response to the first information through the higher-level network communication unit; and
adjusting radio characteristics of the first cell according to the configuration information.

37. A non-transitory computer readable medium storing a program for causing a computer to perform processing for instructing a mobile station connected to a second base station to measure a radio signal that arrives from a first base station, and for receiving a measurement result by the mobile station, the processing comprising:
receiving first information from each of the at least one first base station; and
determining a first base station which is to be measured by the mobile station from among the at least one first base station,
wherein the first information includes at least one of a first radio parameter related to a first cell formed by a source base station from which the first information originates and a second radio parameter related to a second cell formed by the second base station and measured by the source base station.
